(19) United States
(12) Patent Application Publication
(10) Pub. No.: US 2025/0148434 A1
(43) Pub. Date: May 8, 2025

(54) BLOCKCHAIN-BASED PAYMENT CONTROL METHOD AND APPARATUS, AND DEVICE AND MEDIUM

(71) Applicant: SHENZHEN FUTU NETWORK TECHNOLOGY CO., LTD., Shenzhen (CN)

(72) Inventors: Zesheng WU, Shenzhen, Guangdong (CN); Zhipeng YAN, Shenzhen, Guangdong (CN); Zewen YIN, Shenzhen, Guangdong (CN); Yanheng CHENG, Shenzhen, Guangdong (CN); Yongpeng WU, Shenzhen, Guangdong (CN)

(21) Appl. No.: 19/012,912

(22) Filed: Jan. 8, 2025

Related U.S. Application Data
(63) Continuation of application No. PCT/CN2022/140785, filed on Dec. 21, 2022.

(30) Foreign Application Priority Data
Aug. 26, 2022 (CN) 202211038105.7

(51) Int. Cl. G06Q 20/06; G06Q 40/04

(52) U.S. Cl. CPC G06Q 20/06; G06Q 40/04

(57) ABSTRACT

Provided are a blockchain-based payment control method, a payment control apparatus, a device and a medium. The method includes: verifying a payment request for a securities account initiated by a requester, where the payment request includes a payment amount and a payee; in response to the payment request passing the verification, performing fund deduction on the securities account based on the payment amount, deducting a quota corresponding to the payment amount from a payment quota corresponding to the requester, and instructing an auxiliary payment platform to transfer the payment amount to the payee; transferring funds corresponding to the payment quota to the auxiliary payment platform to generate a transaction result; and verifying the transaction result through a smart contract and uploading data generated during the payment to a blockchain in response to the transaction result passing the verification.

### CROSS-REFERENCE TO RELATED APPLICATIONS

This application is a continuation of International Patent Application No. PCT/CN2022/140785, filed on Dec. 21, 2022, which claims the priority to Chinese Patent Application No. 202211038105.7, entitled “BLOCKCHAIN-BASED PAYMENT CONTROL METHOD AND APPARATUS, DEVICE, AND MEDIUM” and filed on Aug. 26, 2022, the entire contents of which are incorporated herein by reference.

### FIELD

The present disclosure relates to the field of the Internet technology, and in particular, to a payment control method and apparatus, an electronic device, and a computer-readable storage medium.

### BACKGROUND

Securities are a general term for certificates of various economic rights and interests, and are written confirmations proving that securities holders have the right to obtain their due rights and interests according to contents described in their securities. Different securities are divided as their nature into evidence securities, voucher securities, valuable securities, and the like. Some securities may be traded on the market. The existence of securities enlivens finance, economy, and investment. The securities generally include stocks, bonds, funds, warrants, and the like.

At present, when users want to use funds in their securities accounts, they must transfer the funds in their securities accounts to their bank accounts through a bank-securities transfer function, and then they may use the funds in the bank accounts for consumption. Therefore, in the related art, a business process of using the funds in the securities account is cumbersome, and requires many identity verifications and transaction verifications, which reduces a business throughput of a payment system, thus causing problems of low transaction efficiency and low safety of the securities account.

### SUMMARY

In order to solve the above technical problems, embodiments of the present disclosure provide a payment control method and apparatus, an electronic device, and a computer-readable storage medium, which can improve data throughput performance in payment scenarios, and improve real-time performance and safety in payment.

According to an aspect of the embodiments of the present disclosure, a payment control method is provided. The method includes: verifying a payment request for a securities account initiated by a requester, where the payment request includes a payment amount and a payee; in response to the payment request passing the verification, performing fund deduction on the securities account based on the payment amount, deducting a quota corresponding to the payment amount from a payment quota corresponding to the requester, and instructing an auxiliary payment platform to transfer the payment amount to the payee; transferring funds corresponding to the payment quota to the auxiliary payment platform to generate a transaction result; and verifying the transaction result through a smart contract and uploading data generated during the payment to a blockchain in response to the transaction result passing the verification.

According to an aspect of the embodiments of the present disclosure, a payment control apparatus is provided. The apparatus includes: a payment verification module configured to verify a payment request for a securities account initiated by a requester, where the payment request includes a payment amount and a payee; a payment processing module configured to, in response to the payment request passing the verification, perform fund deduction on the securities account based on the payment amount, deduct a quota corresponding to the payment amount from a payment quota corresponding to the requester, and instruct an auxiliary payment platform to transfer the payment amount to the payee; a transaction result generation module configured to transfer funds corresponding to the payment quota to the auxiliary payment platform to generate a transaction result; and a data uploading module configured to verify the transaction result through a smart contract and upload data generated during the payment to a blockchain in response to the transaction result passing the verification.

According to an aspect of the embodiments of the present disclosure, an electronic device is provided. The electronic device includes one or more processors and a storage apparatus for storing one or more programs. The one or more programs, when executed by the electronic device, cause the electronic device to implement the payment control method as described above.

According to an aspect of the embodiments of the present disclosure, a computer-readable storage medium is provided. The computer-readable storage medium has a computer program stored thereon. The computer program, when executed by a processor, implements the payment control method as described above.

According to an aspect of the embodiments of the present disclosure, a computer program product is provided. The computer program product includes a computer request. The computer request, when executed by a processor, implements the payment control method as described above.

In the technical solutions provided by the embodiments of the present disclosure, the payment request for the securities account initiated by the requester is verified. In response to the payment request passing the verification, the fund deduction is performed on the securities account based on the payment amount, the quota corresponding to the payment amount is deducted from the payment quota corresponding to the requester, and the auxiliary payment platform is instructed to transfer the payment amount to the payee. The funds corresponding to the payment quota are transferred to the auxiliary payment platform. The transaction result is verified through the smart contract, and the data generated during the payment is uploaded to the blockchain in response to the transaction result passing the verification. On the one hand, a problem of low fund use efficiency occurring in bank-securities transfer because the funds in the securities account are not directly available is solved, which simplifies steps of a user using the funds in the securities account, thus improving the data throughput performance of the payment scenario and improving the real-time performance and transaction efficiency in payment. On the other hand, payment and transaction processes are verified through a smart contract technology in the blockchain, and data generated during the entire transaction is uploaded to the chain, which improves safety and reliability of transaction payment.

It should be understood that the above general description and the following detail description are exemplary and explanatory only, rather than limit the present disclosure.

### BRIEF DESCRIPTION OF THE DRAWINGS

The accompanying drawings, which are incorporated in this specification and constitute a part of this specification, illustrate embodiments consistent with the present disclosure and, together with the description, serve to explain the principles of the present disclosure. Apparently, the drawings as described below are merely some embodiments of the present disclosure. Based on these drawings, other drawings can be obtained by those skilled in the art without creative efforts, in which:

FIG. 1 is a schematic diagram of an exemplary application environment where a technical solution of an embodiment of the present disclosure may be applied.

FIG. 2 is a flowchart of a payment control method according to an exemplary embodiment of the present disclosure.

FIG. 3 is a schematic structural diagram of a blockchain according to an exemplary embodiment of the present disclosure.

FIG. 4 is a schematic diagram of performing payment verification on a payment request according to an exemplary embodiment of the present disclosure.

FIG. 5 is a schematic diagram of a verification process for a dynamic verification code according to an exemplary embodiment of the present disclosure.

FIG. 6 is a schematic diagram of an identity verification interface according to an exemplary embodiment of the present disclosure.

FIG. 7 is a schematic diagram of a payment selection interface according to an exemplary embodiment of the present disclosure.

FIG. 8 is a flowchart of a payment control method according to another exemplary embodiment of the present disclosure.

FIG. 9 is a schematic diagram of a binding selection interface according to an exemplary embodiment of the present disclosure.

FIG. 10 is a schematic diagram of binding a virtual securities payment card and a securities account according to an exemplary embodiment of the present disclosure.

FIG. 11 is a schematic diagram of an interface for querying payment data of a virtual securities payment card according to an exemplary embodiment of the present disclosure.

FIG. 12 is a schematic diagram of performing frozen processing on a virtual securities payment card according to an exemplary embodiment of the present disclosure.

FIG. 13 is a schematic diagram of performing payment quota adjustment processing on a virtual securities payment card according to an exemplary embodiment of the present disclosure.

FIG. 14 is a schematic diagram of a unified model language of virtual securities payment card management software according to an exemplary embodiment of the present disclosure.

FIG. 15 is a flowchart of a payment control method according to another exemplary embodiment of the present disclosure.

FIG. 16 is a block diagram of a payment control apparatus according to an exemplary embodiment of the present disclosure.

FIG. 17 is a schematic structural diagram of a computer system of an electronic device suitable for implementing the embodiments of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the present disclosure. Instead, they are merely examples of apparatuses and methods consistent with aspects related to the present disclosure as recited in the appended claims.

The block diagrams illustrated in the drawings are functional entities and do not necessarily correspond to physically independent entities. That is, these functional entities may be implemented in a form of application programs, or in one or more hardware modules or integrated circuits, or in different networks and/or processor apparatuses and/or microcontroller apparatuses.

The flowcharts illustrated in the drawings are merely illustrative, rather than necessarily include all contents and operations/steps, nor necessarily need to be performed in the described order. For example, some operations/steps may also be decomposed, while some operations/steps may be combined or partially combined, so an order of actual execution may be changed as actual situations.

It needs to be noted that “a plurality of” referred to herein means two or more. The expression “and/or” describes the association relationship of the associated objects and expresses that three kinds of relationships may exist. For example, A and/or B may indicate that three cases where A exists independently, A and B exist at the same time, and B exists independently. The character “/” generally indicates that the associated objects before and after the character are in an “or” relationship.

In the related art, when users need to use funds in a securities account, available funds in the securities account need to be transferred to a bank account via a bank-securities transfer, and then the funds in the bank account are usable for consumption. However, this process requires the users to perform a bank-securities transfer every time they have a need to use funds, making steps for fund use complicated. Moreover, due to poor timeliness of the bank-securities transfer, the funds cannot be transferred immediately into the bank account after the bank-securities transfer operation is executed, resulting in delays in satisfying users' fund use needs. In addition, the users cannot accurately gauge an amount of funds transferred from the securities account to the bank account, resulting in low fund use efficiency.

Based on this, the embodiments of the present disclosure provide a payment control method and apparatus, an electronic device, and a computer-readable storage medium, to solve the above technical problems.

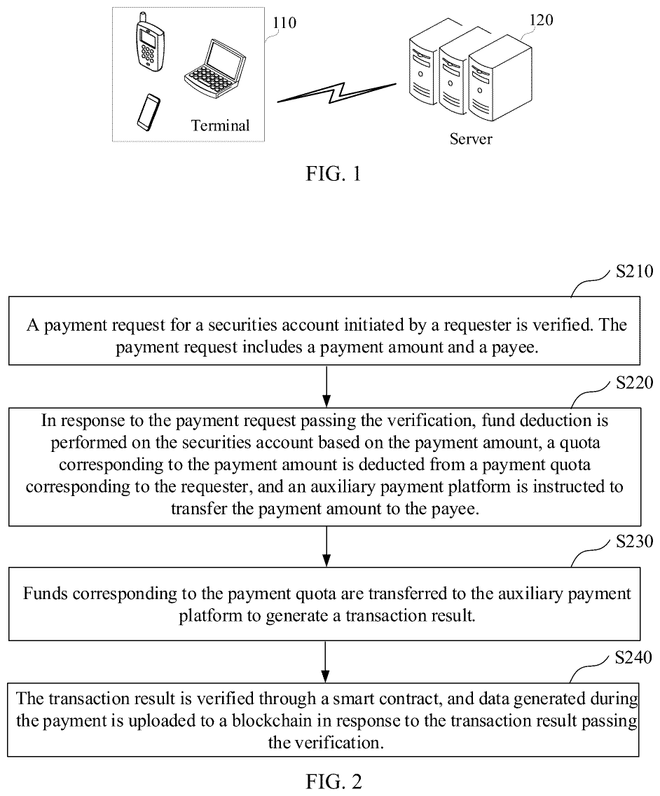

The payment control method according to the embodiments of the present disclosure is described below. FIG. 1 is a schematic diagram of an implementation environment for the payment control method in the present disclosure. As illustrated in FIG. 1, the implementation environment includes a terminal 110 and a server 120. The terminal 110 and the server 120 may be directly or indirectly connected by wired or wireless communication, which is not limited in the present disclosure herein.

The terminal 110 may be a smartphone, a tablet computer, a notebook computer, a desktop computer, a smart speaker, a smart watch, an in-vehicle terminal, or the like, but is not limited thereto. The terminal 110 may generally refer to one of a plurality of terminals, and this embodiment only uses the terminal 110 as an example for description. Those skilled in the art may recognize that a quantity of the terminals described above may be more or fewer. For example, the quantity of the terminals as described above may be only one, or dozens, or hundreds, or even more. In this case, the implementation environment of the image processing method as described above may include other terminals. The embodiments of the present disclosure do not limit the quantity of the terminals and the type of the devices.

The server 120 may be an independent physical server, a server cluster or a distributed system composed of a plurality of physical servers. The server 120 may also be a cloud server providing basic cloud computing services such as cloud services, cloud databases, cloud computing, cloud functions, cloud storage, network services, cloud communication, middleware services, domain name services, security services, content delivery network (CDN), and big data and artificial intelligence platforms. The server 120 is configured to provide background services for application programs running on the terminal 110.

In some embodiments, the wireless network or wired network as described above uses standard communication techniques and/or protocols. The network is typically the Internet, but may be any network including, but not limited to, a local area network (LAN), a metropolitan area network (MAN), a wide area network (WAN), a mobile, wired or wireless network, or any combination of a private network or a virtual private network. In some embodiments, data exchanged over a network is represented by using techniques and/or formats including a hyper text mark-up language (HTML), an extensible markup language (XML), and the like. All or some of links may also be encrypted by using conventional encryption techniques of secure socket layer (SSL), transport layer security (TLS), virtual private network (VPN), internet protocol security (IPsec), and the like. In other embodiments, customized and/or dedicated data communication techniques may also be used to replace or supplement the data communication techniques as described above.

It can be understood that in specific implementations of the present disclosure, related data of account information, user data, transaction data, and the like are involved. When the embodiments of the present disclosure are applied to specific products or technologies, user's permission, consent, or authorization is required, and collection, use, and processing of relevant data comply with relevant laws, regulations, and standards of relevant countries and regions.

The blockchain-based payment control method according to the embodiments of the present disclosure may be executed by the server 120 or by the terminal 110, or by the server 120 and the terminal 110 together. The terminal 110 executes the blockchain-based payment control method according to the embodiments of the present disclosure, which may also be performed by a client installed on the terminal 110.

FIG. 2 is a flowchart of a blockchain-based payment control method according to an embodiment of the present disclosure. As illustrated in FIG. 2, the blockchain-based payment control method at least includes steps S210 to S240, which are described in detail below.

At step S210, a payment request for a securities account initiated by a requester is verified. The payment request includes a payment amount and a payee.

It should be noted that the securities account refers to a ledger established by a securities registration and clearing institution for investors, used to accurately record types, names, quantities, and corresponding rights and interests, and changes of securities held by the investors, for trading of securities products.

Exemplarily, the server may be provided with a virtual securities payment card, to bind at least one securities account with the virtual securities payment card to establish a payment link between the securities account and the virtual securities payment card, i.e., the requester may use funds in the securities account by invoking the virtual securities payment card.

The virtual securities payment card simulates a physical payment card based on card data on the terminal to achieve a payment function. The virtual securities payment card may have a corresponding physical card or may not have a corresponding physical card. The virtual securities payment card may be displayed on the terminal, for example, in a card form, a two-dimensional code form, or the like. The present disclosure does not limit this.

Exemplarily, payment software having the payment function may be installed on the terminal. The virtual securities payment card may be bound with the payment software. The payment request is generated by detecting a payment operation performed by the requester on the payment software for the virtual securities payment card. For example, shopping software is also installed on the terminal. After the requester browses in the shopping software and selects products, the shopping software displays a plurality of payment manners to the user, and the requester may select one of the plurality of payment manners to make payment, and each payment manner corresponds to one payment software. Then, the selected payment software initiates a payment request for the securities account bound with the virtual securities payment card. In the payment request, a total product price corresponding to the product selected by the requester is taken as the payment amount, and a seller of the product selected by the requester is taken as the payee.

In the embodiment of the present disclosure, the payment request initiated by the requester is verified. For example, it is verified whether payment order information carried in the payment request is correct, whether the requester of the initiated payment request is consistent with account information corresponding to the securities account, and the like. The present disclosure does not limit this.

At step S220, in response to the payment request passing the verification, fund deduction is performed on the securities account based on the payment amount, a quota corresponding to the payment amount is deducted from a payment quota corresponding to the requester, and an auxiliary payment platform is instructed to transfer the payment amount to the payee.

The auxiliary payment platform is a platform that can directly transfer funds. The auxiliary payment platform may be a bank account, a third-party payment platform, or the like, and the third-party payment platform may be payment software installed in the terminal, which is not limited herein by the present disclosure. It needs to be understood that, in the embodiments of the present disclosure, an available fund quota in the auxiliary payment platform is greater than the payment amount in the payment request by default.

It can be understood that the server stores a payment quota corresponding to each requester, and the payment quota is used for restricting an upper limit of a fund amount usable by the requester within a predetermined time period, and recording fund use situations of the requester within the predetermined time period. For example, when a payment quota of a requester A is 5,000 yuan per month, the requester A may use up to 5,000 yuan within one month.

Exemplarily, the payment quota may be set for the virtual securities payment card of the requester, i.e., payment made from each securities account included in the virtual securities payment card may be associated with the payment quota of the virtual securities payment card. Alternatively, the payment quota may be set for each securities account included in the virtual securities payment card, i.e., the payment made from each securities account is associated with the payment quota corresponding to each securities account. Alternatively, a total payment quota may be set for the virtual securities payment card, and a sub-payment quota may be set for each securities account included in the virtual securities payment card, i.e., on a premise that an amount of funds paid from each securities account within the predetermined time period is smaller than or equal to the sub-payment quota, a sum of the amounts of the funds paid from the securities accounts within the predetermined time period is smaller than or equal to the total payment quota. The setting of the payment quota may be flexibly selected as actual application situations, and is not limited herein by the present disclosure.

After the payment request passes the verification, the server deducts funds corresponding to the payment amount from the securities account, and transfers the funds to a total fund account predetermined by the server, and then transmits a payment instruction to the auxiliary payment platform, so that the auxiliary payment platform transfers the payment amount to the payee, to ensure that the payee may receive the payment amount timely, improving payment completion efficiency. In addition, the quota corresponding to the payment amount is deducted from the payment quota corresponding to the requester, to record the fund use situations of the requester.

At step S230, funds corresponding to the payment quota are transferred to the auxiliary payment platform to generate a transaction result.

Since the payment quota records the fund use situations of the requester within the predetermined time period, a fund transfer amount of the auxiliary payment platform may be obtained by querying a change of the payment quota of the requester within the predetermined time period. Further, the server transfers funds corresponding to the fund transfer amount to the auxiliary payment platform.

Fund transfer processing may be performed by the auxiliary payment platform one time based on the change of the payment quota every predetermined time period, to reduce a number of times of interactions between the server and the auxiliary payment platform, saving computing resources. Alternatively, every time one payment task corresponding to one payment request is completed, the fund transfer processing may be performed by the auxiliary payment platform one time, to ensure that the auxiliary payment platform may timely receive an advance amount after advancing, to ensure real-time performance of fund circulation. The present disclosure does not limit this.

In some implementations, the transferring the funds corresponding to the payment quota to the auxiliary payment platform includes: obtaining a quota change value of a payment quota corresponding to the auxiliary payment platform within a predetermined time period; and transferring funds corresponding to the quota change value to the auxiliary payment platform.

For example, the server may perform an account check with the auxiliary payment platform every 24 hours. An account check process may be described below. The server detects the quota change value of the payment quota corresponding to the requester within 24 hours, then receives a total amount of payment amounts which is transferred to all payees for the request within 24 hours and which is transmitted by the auxiliary payment platform, and determines whether the quota change value of the payment quota is consistent with the total amount of the payment amounts. In response to the quota change value of the payment quota being consistent with the total amount of the payment amounts, the funds corresponding to the quota change value are transferred to the auxiliary payment platform.

In some implementations, the blockchain-based payment control method may be applied to a node of a blockchain network. The node of the blockchain network may be any node accessing the blockchain network. The node may be any form of computing device, such as a server, a terminal, and the like. Then, a smart contract is used in the blockchain network to constrain a fund transfer process between the server and the auxiliary payment platform.

It needs to be noted that the smart contract is a computer protocol designed to disseminate, verify or enforce contracts in an information manner. A purpose of the smart contract is to provide a safer method than a traditional contract and to reduce other transaction costs related to the contract. The smart contract allows for trustworthy transactions without third parties, and these transactions are traceable and irreversible.

Exemplarily, the node of the blockchain network may receive a payment request submitted by the terminal for the securities account, and then perform fund deduction on the securities account, to transfer funds in the securities account to a total fund account in the node of the blockchain network. Then, the smart contract is invoked to determine funds corresponding to the payment amount of the payment request in the total fund account, states of these funds are modified to locked states, and the auxiliary payment platform is instructed to transfer a corresponding amount of payment amounts to the payee, to ensure that the payee can receive the payment amount timely, improving the payment completion efficiency. Locking the funds corresponding to the payment amount in the total fund account means that only a node executing the smart contract may perform operations on the funds, and all other nodes may each not perform operations on the funds.

After detecting that the auxiliary payment platform completes the payment, a transaction result fed back by the auxiliary payment platform is received, and the transaction result is verified. In response to the transaction result indicating a successful payment, the smart contract is invoked to transfer the funds corresponding to the payment amount in the total fund account to the auxiliary payment platform.

At step S240, the transaction result is verified through a smart contract, and data generated during the payment is uploaded to a blockchain in response to the transaction result passing the verification.

Since the smart contract in the blockchain has characteristics of automatic contract fulfillment, transparent execution rules and logic, open and unchangeable results, after the auxiliary payment platform implements the payment task, the smart contract verifies a transaction result of the auxiliary payment platform, which ensures accuracy and fairness of the verification result, and simplifies a complexity degree of executing the payment task in the securities account. The data generated during the payment is uploaded to the blockchain after the transaction result passes the verification. The data generated during the payment includes, but is not limited to, the payment request of the securities account and the verification result of the payment request, and transaction data generated during the fund deduction, such as the quota corresponding to the payment amount and the payment manner.

The blockchain is a chain data structure formed by combining data blocks sequentially in a chronological order and a distributed ledger ensuring that data is unchangeable and unforgeable in a cryptography manner. A plurality of independent distributed nodes (i.e. nodes of the blockchain network) keep same records. A blockchain technology achieves decentralization and becomes the cornerstone of credible digital asset storage, transfer, and transaction.

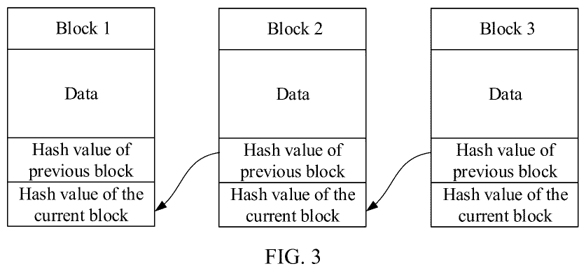

By taking a schematic structural diagram of the blockchain illustrated in FIG. 3 as an example, whenever new data needs to be written into the blockchain, the data will be summarized into one block and added to a tail end of an existing blockchain. Newly added blocks of each node are ensured to be exactly the same through a consensus algorithm. Each block records a plurality of transaction records, while includes a hash value of a previous block. All blocks save the value in the previous block in this way, and are connected in sequence to form the blockchain. The hash value of the previous block is stored in a block header of a next block in the blockchain. When transaction data in the previous block changes, a hash value of the current block also changes accordingly. Therefore, the transaction data uploaded to the blockchain network is difficult to be changed, and performing a payment transaction on the blockchain realizes openness and transparency during the payment and improves payment reliability.

In some implementations, funds available in the securities account corresponding to the payment request may be a specific amount in a fund balance, or a specific amount after virtual resources in the securities account are exchanged for funds. For example, there are purchased funds, stocks, and the like in the securities account. An amount of funds corresponding to virtual resources that is currently tradable in the securities account may be used as transferable funds. The virtual resources that is currently tradable in the securities account refer to virtual resources that is currently salable. By using the virtual resources as tradable funds, a fund source is enriched, and a user's use experience is improved.

In the present disclosure, after the payment request passes the verification, the fund deduction may be performed on the securities account, and the auxiliary payment platform may be instructed to advance the payment amount, to transfer the corresponding payment amount to the payee, thus ensuring that a payment business may be completed timely. Then, a specific advance of the auxiliary payment platform is transferred to the auxiliary payment platform, to complete the payment process. In this way, a problem of low fund use efficiency occurring in bank-securities transfer because the funds in the securities account are not directly available is solved, which simplifies steps of the user using the funds in the securities account, thus improving data throughput performance of a payment scenario and improving real-time performance in payment.

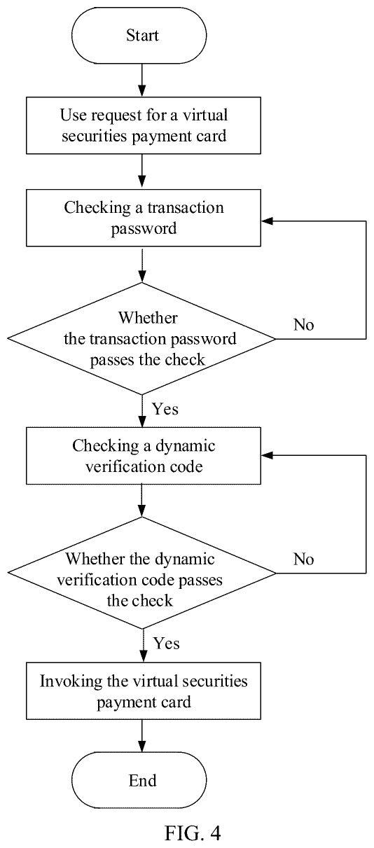

Referring to FIG. 4, FIG. 4 is a schematic diagram of performing verification on the payment request for the securities account initiated by the requester according to an embodiment of the present disclosure.

As illustrated in FIG. 4, the requester transmits a use request of the virtual securities payment card to the server through the terminal, and the server transmits a transaction password obtaining request of the virtual securities payment card to the terminal based on the use request of the virtual securities payment card, to allow the terminal to display a transaction password input box to the requester based on the transaction password obtaining request. Further, the server obtains a transaction password inputted by the requester to the transaction password input box and fed back by the terminal, and checks whether the transaction password fed back by the terminal is correct based on a pre-saved transaction password in association with the virtual securities payment card. In response to the transaction password being correct, a dynamic verification code obtaining request of the virtual securities payment card is transmitted to the terminal. In response to a dynamic verification code being correct, the payment request passes the identity verification, and then the virtual securities payment card is invoked.

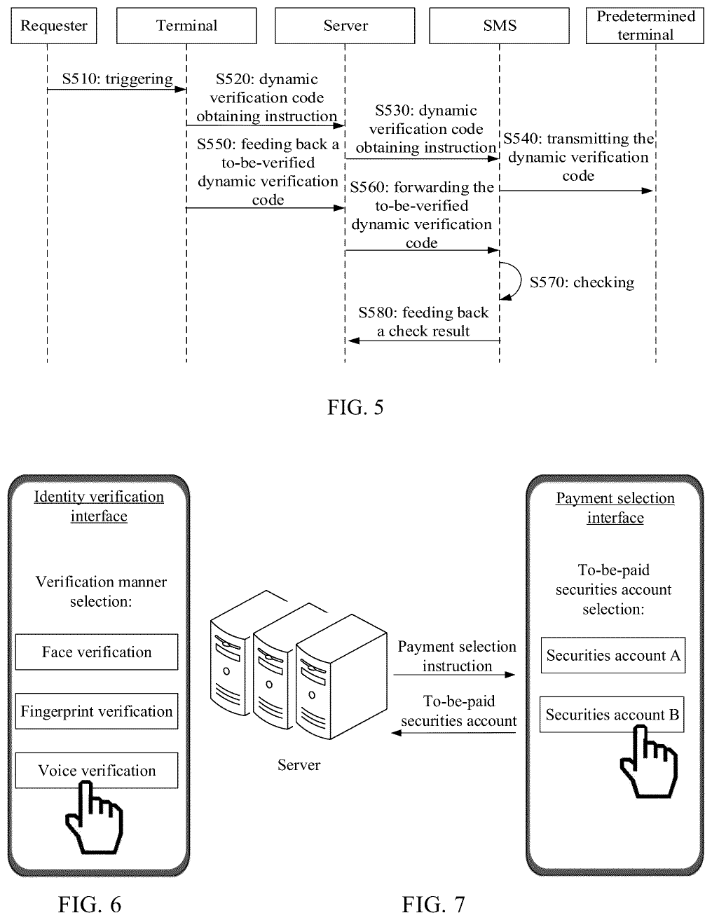

A verification process for the dynamic verification code may be as illustrated in FIG. 5.

At step S510, the requester triggers a dynamic verification code confirmation button, and the dynamic verification code confirmation button is displayed by the terminal to the requester based on the dynamic verification code obtaining request.

At step S520, the terminal transmits a dynamic verification code obtaining instruction to the server and causes the terminal to display a dynamic verification code input box.

At step S530, the server forwards the dynamic verification code obtaining instruction to a short message service (SMS) platform.

At step S540, the SMS platform transmits a dynamic verification code to a predetermined terminal based on the dynamic verification code obtaining instruction. The predetermined terminal refers to a terminal where a subscriber identity module (SIM) corresponding to the virtual securities payment card is located. The predetermined terminal may be the same as or different from the terminal that transmits the dynamic verification code obtaining instruction as mentioned above.

At step S550, the terminal transmits the dynamic verification code, that is inputted by the requester to the dynamic verification code input box, to the server.

At step S560, the server forwards the received dynamic verification code to the SMS platform.

At step S570, the SMS platform checks whether the received dynamic verification code is consistent with the dynamic verification code transmitted to the predetermined terminal.

At step S580, the SMS platform feeds back a check result to the server. In response to determining that the received dynamic verification code is consistent with the dynamic verification code transmitted to the predetermined terminal, the SMS platform feeds back a result of passing the check to the server. In response to determining that the received dynamic verification code is inconsistent with the dynamic verification code transmitted to the predetermined terminal, the SMS platform feeds back a result of failing to pass the check to the server.

The identity verification is performed on the requester corresponding to the payment request by combining the transaction password and the dynamic verification code, to improve accuracy of the identity verification in various verification manners, ensuring payment safety.

In some implementations, as illustrated in FIG. 6, when selecting to use the virtual securities payment card for payment, the terminal enters an identity verification interface corresponding to the virtual securities payment card, and the identity verification interface may be provided with a plurality of verification manner selection buttons. For example, the verification manner selection button includes “face verification”, “fingerprint verification”, and “voice verification”. Then, corresponding identity verification information is obtained based on a verification manner selected by the requester. For example, when the verification manner selected by the requester is the “face verification”, face information of the requester is obtained through an image obtaining device on the terminal. When the verification manner selected by the requester is the “fingerprint verification”, fingerprint information of the requester is obtained through a fingerprint obtaining device on the terminal. When the verification manner selected by the requester is the “voice verification”, voice information of the requester is obtained by a voice obtaining device on the terminal. The plurality of verification manners are set, and the identity verification is performed based on the verification manner selected by the requester, to improve diversity and selectivity of the requester performing the identity verification, thus improving a use experience of the requester.

Then, the terminal generates the payment request based on the obtained identity verification information and the order information associated with the payment request, and transmits the payment request to the server. The server stores identity information of each requester. After receiving a payment request uploaded by the terminal, the server performs identity verification on the identity verification information in the payment request based on the stored identity information and performs order verification on the order information in the payment request. Performing order verification on the order information in the payment request may be to detect whether the order information is correct, for example, to detect whether signature information of the order information is correct, to effectively identify forged order information and ensure the payment safety.

In response to passing both the identity verification and the order verification, the verification result of the payment request is the payment request passing the payment verification. In response to failing to pass at least one of the identity verification and the order verification, the verification result of the payment request is the payment request fails to pass the payment verification.

The securities account corresponding to the payment request may be a securities account directly designated by the requester or a securities account obtained after the server screens a plurality of securities accounts corresponding to the requester based on the payment request.

For example, in response to passing the payment verification, an available quota of each securities account included in the virtual securities payment card is obtained. Then, a securities account having an available amount greater than or equal to the payment amount is taken as a to-be-paid securities account. It can be understood that one virtual securities payment card may be bound with a plurality of securities accounts, and the securities account having the available amount greater than or equal to the payment amount is taken as the to-be-paid securities account, to ensure that a payment operation may be correctly performed on the to-be-paid securities account subsequently.

The available quota refers to an amount of funds available to the requester.

In some embodiments, the available quota of the securities account may be determined based on the total fund amount in the securities account. For example, the total fund amount in the securities account may be a specific amount in the fund balance of the securities account or a sum of adding specific amounts in the fund balance and specific amounts in the securities account after the virtual resources are exchanged for funds, which is not limited herein by the present disclosure.

Exemplarily, a remaining available quota of funds of each securities account is determined based on the payment quota. Then, a minimum of the remaining available quota of the funds and the total amount of the funds of each securities account is taken as an available quota corresponding to the securities account. For example, the securities accounts include a securities account A and a securities account B. A total fund amount in the securities account A is 100 yuan, and a total fund amount in the securities account B is 700 yuan. A payment quota set for the virtual securities payment card is 1,000 yuan per day. It is obtained that the virtual securities payment card has paid 600 yuan by querying a historically intraday payment record of the virtual securities payment card. Therefore, the remaining available quota of the funds of each securities account is 400 yuan. Further, an available quota of the securities account A is 100 yuan, and an available quota of the securities account B is 400 yuan.

In some embodiments, when there are a plurality of securities accounts with an available quota greater than or equal to the payment amount, priorities of these securities accounts may be obtained, and a securities account with a highest priority may be taken as the to-be-paid securities account. The priority may be predetermined for each securities account, or may be dynamically set based on information such as a use frequency and credibility of each securities account, and is not limited in the present disclosure.

In some embodiments, as illustrated in FIG. 7, when there are a plurality of securities accounts with an available quota greater than or equal to the payment amount, a payment selection instruction of the to-be-paid securities account may be transmitted to the terminal, and the terminal displays a payment selection interface of the to-be-paid securities accounts to the requester based on the selection instruction of the to-be-paid securities account. For example, the securities accounts displayed through the payment selection interface include the securities account A and the securities account B, and the securities accounts correspond to different selection buttons. The terminal receives a selection operation performed by the requester on the payment selection interface of the to-be-paid securities accounts, and feeds back the to-be-paid securities account to the server based on the selection operation.

In the embodiment of the present disclosure, safety during the payment is ensured by performing payment verification on the payment request, and the securities account is pre-screened one time based on the available quota of the securities account included in the virtual securities payment card, to ensure that the obtained to-be-paid securities account satisfies payment requirements, to avoid payment failures caused by an insufficient available quota in the securities account, thus avoiding process waste.

In some implementations, when there is no securities account having the available quota greater than or equal to the payment amount in the securities accounts included in the virtual securities payment card, a plurality of available quotas of each securities account included in the virtual securities payment card may be added together. In response to the added available quota is greater than or equal to the payment amount, the securities accounts involved in the adding operation may each be taken as to-be-paid securities accounts, to improve a payment success rate and the use experience of the requester.

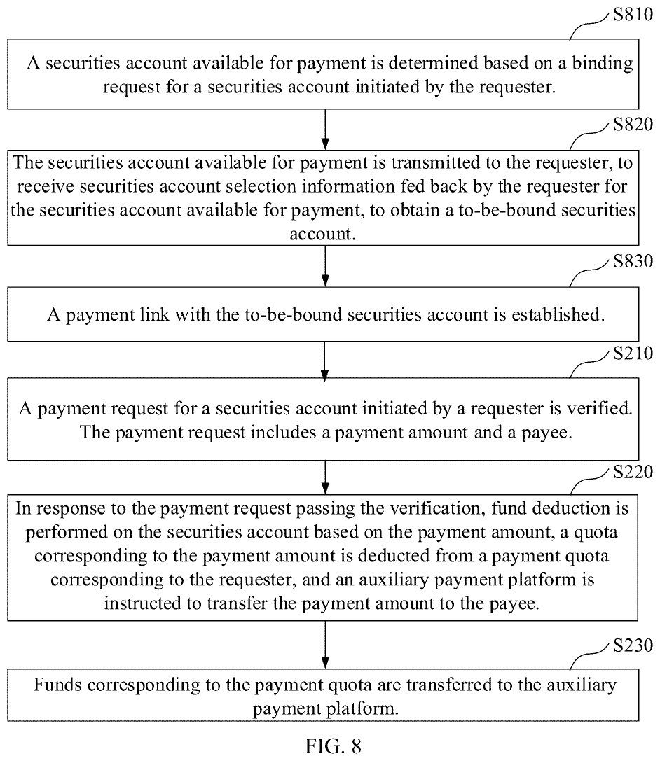

Referring to FIG. 8, FIG. 8 is a flowchart of a blockchain-based payment control method according to another exemplary embodiment of the present disclosure. As illustrated in FIG. 8, in an exemplary embodiment, before step S210 of verifying the payment request for the securities account initiated by the requester, the method may further include the following steps.

At step S810, a securities account available for payment is determined based on a binding request for a securities account initiated by the requester.

The securities account available for payment means that the securities account includes funds available for payment.

One virtual securities payment card may be bound with a plurality of securities accounts, or one securities account may be bound with a plurality of virtual securities payment cards, which is not limited in the present disclosure.

It needs to be noted that both the virtual securities payment card and the securities account have corresponding user information, and the user information of the virtual securities payment card may be the same as or different from the user information of the securities account. For example, considering safety of the virtual securities payment card and safety of the securities account, in order to facilitate subsequent management, the user information of the virtual securities payment card needs to be the same as the user information of the securities account. Considering binding flexibility between the virtual securities payment card and the securities account, the user information of the virtual securities payment card needs to be different from the user information of the securities account. Alternatively, a corresponding binding strategy may be selected based on corresponding credibility of the virtual securities payment card and corresponding credibility of the securities account, so that a binding method between the virtual securities payment card and the securities account is more suitable for the actual situations. The binding method between the virtual securities payment card and the securities account may be flexibly selected as the actual situations, and the present disclosure does not limit this.

In some implementations, the determining the securities account available for payment based on the binding request for the securities account initiated by the requester includes: querying a securities account state of a securities account corresponding to the requester; calculating credibility of a securities account with the securities account state being a normal state based on historical transaction information of the securities account with the securities account state being the normal state; and taking a securities account with credibility satisfying a predetermined condition as the securities account available for payment.

In some embodiments, the securities account corresponding to the requester may be a securities account associated with the requester. For example, the server obtains identity information corresponding to the virtual securities payment card operated by the requester, and the identity information includes a user name, an identity identifier, an identity image, and the like. The user name refers to a user's name. The identity identifier may be a user's ID number, a user's passport number, or other identities that uniquely identify the user's identity. The identity image refers to head portrait information corresponding to the identity identifier. For example, in response to the identity identifier being the ID number, the identity information is head portrait information on an ID card. In response to the identity identifier being the passport number, the corresponding head portrait information is head portrait information on a passport. The virtual securities payment card may have its own virtual card identifier, and the virtual card identifier may be composed of identity information of a cardholder, to facilitate linking the identity information of the cardholder with the virtual card. For example, all the securities accounts are queried through the identity information of the cardholder, and a securities account matching the identity information of the cardholder is taken as the securities account corresponding to the requester.

In some embodiments, the securities account corresponding to the requester may be securities accounts in all securities software in the terminal corresponding to the requester. For example, in response to querying securities account login records of all the securities software in the terminal corresponding to the requester, all securities account numbers involved in the login records are taken as securities accounts corresponding to the virtual securities payment card.

The securities account state of the securities account may include a normal state, a frozen state, and the like. The securities account with the securities account state being the normal state refers to an account that is usable normally. For example, it is possible to normally use a fund balance in the securities account, normally perform a securities transaction, and the like. A securities account with a securities account state being a frozen state refer to an account that is not usable abnormally, for example, it is impossible to perform account login, the securities transaction, and the like.

Credibility calculation may be to calculate the credibility of the requester based on the historical transaction information of the requester. For example, by querying whether transaction information marked as illegal occurs in the historical transaction information, the greater an amount of transaction information marked as illegal, the lower the credibility of the requester. The smaller the amount of the transaction information marked as illegal, the higher the credibility of the requester.

The credibility of the securities account with the securities account state being the normal state is calculated based on the historical transaction information of the securities account with the securities account state being the normal state. For example, by querying whether the transaction information marked as illegal occurs in the historical transaction information, the greater the amount of transaction information marked as illegal, the lower the credibility of the securities account. The smaller the amount of the transaction information marked as illegal, the higher the credibility of the securities account. Then, the securities account with the credibility satisfying the predetermined conditions is taken as the securities account available for payment, thus improving subsequent binding efficiency of the securities account.

Specifically, when determining the credibility of the securities account, the historical transaction information of the securities account is obtained, illegal transaction information is extracted from the historical transaction information, and an illegal times Num_vio is counted and a corresponding total amount of illegal orders Tra_vio is obtained, while counting a number of times of normal transactions Num_nor in the historical transaction information and a corresponding total amount of normal transactions Tra_nor, to calculate a transaction difference parameter Par_var

$$Par\_var = \frac{{log}_{2} Tra\_nor - {log}_{2} Tra\_vio}{Num\_nor - Num\_vio}$$

Then, based on the transaction difference parameter Par_var, the illegal times Num_vio, and a social activity parameter Par_act of the securities account, the credibility is calculated as follows.

$$Par\_act = α \cdot Par\_act \cdot \frac{\vert Par\_var \vert}{Num\_vio}$$

where α represents a credibility factor. In the above manner, the credibility may be calculated based on the illegal transaction information and other information of the securities account, to measure safety and reputation of the securities account through the credibility. Then, corresponding processing is made based on the credibility of the securities account, thus improving safety and reliability of the transaction.

The securities account with the credibility satisfying the predetermined condition may be a securities account with the credibility greater than or equal to a credibility threshold, or a predetermined quantity of securities accounts ranked in the front after these securities accounts are ranked based on their credibility.

After the reliability is calculated, in this embodiment, label processing may be performed on the transaction data and the data generated during the payment based on the reliability, and the data, as parameters for evaluating reliability of the above information, is uploaded to the chain, improving reliability and objectivity of chain data.

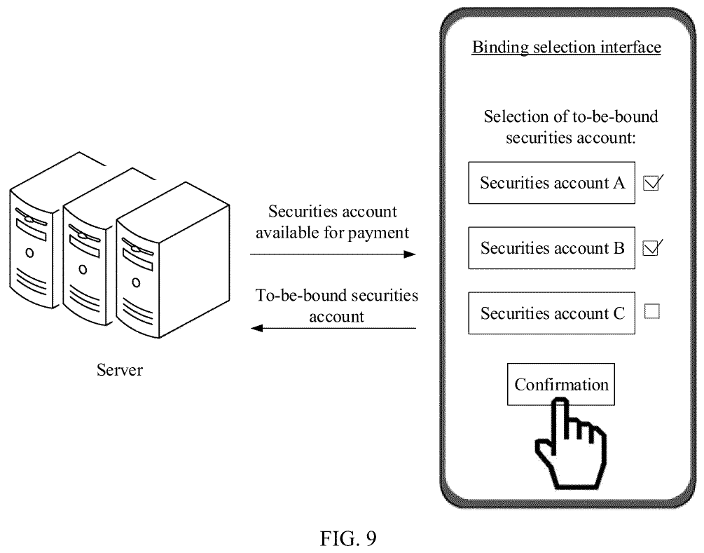

At step S820, the securities account available for payment is transmitted to the requester, to receive securities account selection information fed back by the requester for the securities account available for payment, to obtain a to-be-bound securities account. Exemplarily, referring to FIG. 9, FIG. 9 is a schematic diagram of an interface where the securities account available for payment is selected. As illustrated in FIG. 9, the server transmits the securities account available for payment to the terminal, and the terminal displays a binding selection interface of the securities account to the requester based on the received securities account available for payment. For example, the securities accounts displayed through the binding selection interface include a securities account A, a securities account B, and a securities account C, and the securities accounts correspond to different selection buttons. Then, the requester performs a securities account selection operation on the binding selection interface. Moreover, after the terminal detects that the requester triggers a “determination” button, the to-be-bound securities account is fed back to the server based on the securities account A and the securities account B currently selected by the requester, and then the server determines that the to-be-bound securities accounts are the securities account A and the securities account B, so that the requester may bind a plurality of securities accounts only through one securities account binding operation, which simplifies a securities account binding process and improves the user's use experience.

In some implementations, the transmitting the securities account available for payment to the requester to receive the securities account selection information fed back by the requester for the securities account available for payment to obtain the to-be-bound securities account includes: transmitting a securities account verification request to the requester in response to the securities account selection information; receiving securities account verification information fed back by the requester based on the securities account verification request; performing securities account verification on a selected securities account based on the securities account verification information; and in response to the selected securities account passing the verification, taking the selected securities account as the to-be-bound securities account.

It can be understood that in order to ensure safety of each securities account, a securities account verification step is set for each securities account, to take selected securities account that passes the securities account verification as the to-be-bound securities account.

Exemplarily, after the requester triggers a selection control element of the securities account, a securities account verification interface of the securities account may be displayed to perform corresponding securities account verification on the securities account. Only after the securities account passes the securities account verification, it is indicated that the securities account is successfully selected, otherwise, the securities account selection fails.

At step S830, a payment link with the to-be-bound securities account is established.

Exemplarily, a payment link between the virtual securities payment card and the to-be-bound securities account may be established. The payment link between the virtual securities payment card and the to-be-bound securities account means that a securities account bound with the virtual securities payment card may be invoked through the virtual securities payment card. By binding the securities account with the virtual securities payment card, the virtual securities payment card may be directly invoked to use the funds in the securities account, which improves use efficiency of the funds in the securities account.

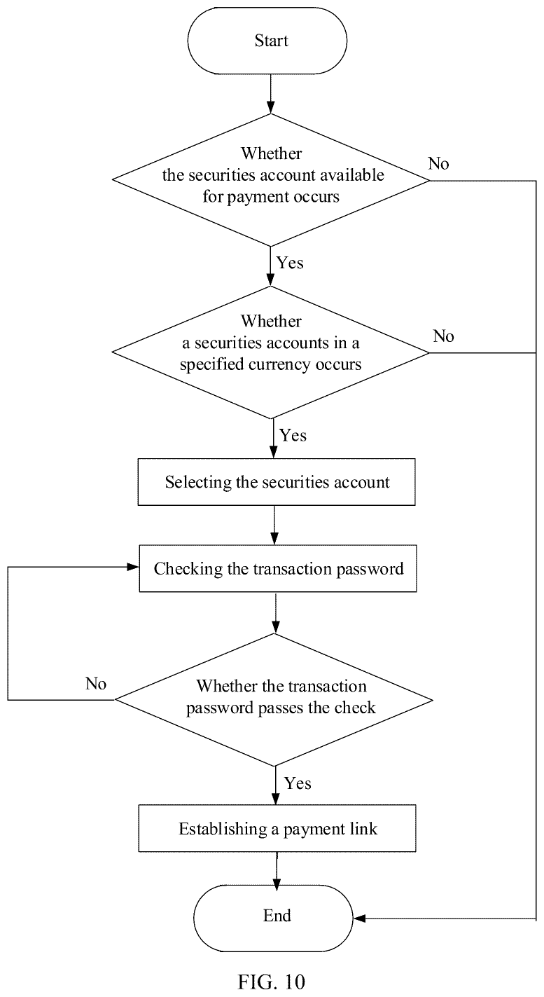

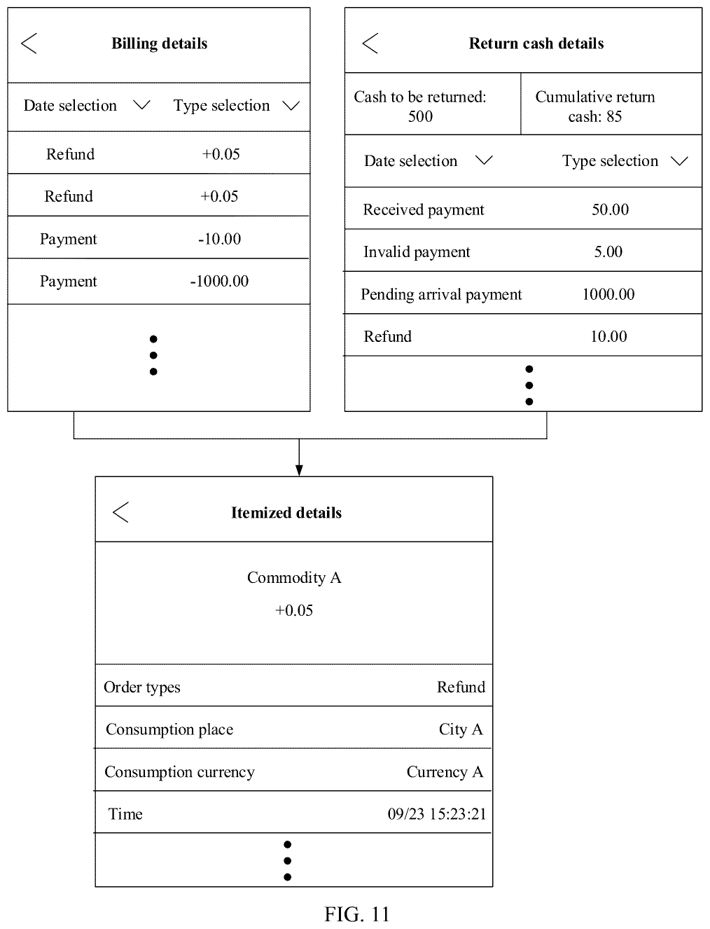

By taking FIG. 10 as an example, an establishment process of the payment link of the securities account is described. As illustrated in FIG. 10, the server determines whether the securities account available for payment occurs based on the securities account binding request. In response to that the securities account available for payment occurs, it is detected whether a securities account in a specified currency occurs. In response to that the securities account in the specified currency occurs, securities account selection information fed back by the requester for a securities account in the specified currency and available for payment is received, to obtain the to-be-bound securities account. Then, a transaction password verification request for the to-be-bound securities account is transmitted to the terminal, to verify a transaction password fed back by the requester through the terminal. In response to the transaction password passing the verification, the payment link between the virtual securities payment card and the to-be-bound securities account is established. In response to the transaction password not passing the verification, the requester is prompted by the terminal to perform the verification again. Then, the payment link between the virtual securities payment card and the to-be-bound securities account is established to complete the securities account binding step.

In some implementations, the establishing the payment link with the to-be-bound securities account further includes: obtaining user information of the requester; obtaining credibility of the requester based on the user information; generating the payment quota corresponding to the requester based on the credibility of the requester; and establishing the payment link with the to-be-bound securities account based on the payment quota corresponding to the requester.

Exemplarily, user information corresponding to the virtual securities payment card and operated by the requester may be obtained to obtain the credibility of the requester based on the obtained user information, then the payment quota corresponding to the requester may be generated based on the credibility of the requester, and the payment link between the virtual securities payment card and the to-be-bound securities account may be established. It can be understood that the higher the credibility of the requester, the higher the payment quota corresponding to the requester; and the lower the credibility of the requester, the lower the payment quota corresponding to the requester.

In some embodiments, a number of times of fund use of the requester within the predetermined time period, an identity verification level during the payment, and the like may also be determined based on the credibility of the requester. For example, the higher credibility of a requesting user, the greater the number of times of fund use within the predetermined time period, and the lower the identity verification level during the payment. The lower the credibility of the requesting user, the smaller the number of times of fund use within the predetermined time period, and the higher the identity verification level during the payment. The identity verification level during the payment refers to a level of a verification manner adopted during the payment. For example, in response to determining that the identity verification level during the payment is a low level based on the credibility of the requesting user, a corresponding verification manner may be transaction password verification. In response to determining that the identity verification level during the payment is a medium level based on the credibility of the requesting user, the corresponding verification manner may be face identification verification. In response to determining that the identity verification level during the payment is a high level based on the credibility of the requesting user, the corresponding verification manner may be the face identification verification and dynamic verification code verification. Corresponding parameters of the payment link are automatically generated through the credibility of the requesting user, so that the established payment link with the securities account is more in line with actual situations of the requester, which improves the user's use experience on the premise of improving the payment safety.

In some implementations, a process of activating the virtual securities payment card is described. In response to a virtual securities payment card activation request initiated by the requester, user information of the requesting user corresponding to the virtual securities payment card activation request is obtained. User identity verification is performed on the user information, and payment configuration parameters are generated based on a credit score corresponding to the user information. In response to the user information passing the user identity verification, the virtual securities payment card is generated based on the user information.

The terminal may display a user information filling interface, and collect the user information of the requesting user based on the user information filling interface. Alternatively, the requester may initiate the virtual securities payment card activation request through virtual securities payment card management software, and the user information of the requester may be user information obtained based on an account identity of an account currently logged on the virtual securities payment card management software. The present disclosure does not limit this.

After the user information of the requester is obtained, the user identity verification is performed on the user information. For example, at least one of face information, fingerprint information, voice information, verification code information, and the like of a current user is obtained through the terminal, to verify whether the obtained information is consistent with the user information. In response to that the obtained information is consistent with the user information, it is indicated that the user information passes the user identity verification. After passing the user identity verification, the virtual securities payment card is generated based on the user information.

In some implementations, the method further includes: receiving a payment data query request for the securities account initiated by the requester, the payment data query request carrying a data type of to-be-queried payment data; determining a data display strategy matching the data type and querying a payment data record corresponding to the data type; and transmitting the data display strategy and the payment data record to the requester, to allow a terminal corresponding to the requester to display the payment data record based on the data display strategy.

By setting different display strategies for pieces of to-be-queried payment data of different data types, the pieces of to-be-queried payment data are distinguished, which allows a terminal side to display the to-be-queried payment data more clearly, facilitating read.

However, the payment data query request may be a request for a designated securities account or a request for all the securities accounts in the virtual securities payment card, and is not limited in the present disclosure.

Description is made by taking a case, that the payment data query request is the request for all the securities accounts in the virtual securities payment card, as an example.

As illustrated in FIG. 11, the data type of the to-be-queried payment data includes billing details and return cash details. When the data type of the to-be-queried payment data carried in the payment data query request is the billing details, a matched data display strategy is a first data display strategy. When the data type of the to-be-queried payment data carried in the payment data query request is the return cash details, the matched data display strategy is a second data display strategy.

The billing details are used for displaying all fund expenditure records and fund refund records that are associated with the virtual securities payment card, and the return cash details are used for displaying all return cash records associated with the virtual securities payment card and generated due to consumption.

In some embodiments, the billing details or the return cash details may be screened based on a date and type. For example, a type of the billing details includes consumption and refund, and a type of the return cash details includes received, invalid, pending arrival, and refund. Further, when detecting that a detail is clicked, the terminal may redirect to an itemized details interface corresponding to the clicked detail, to display a detailed content of the detail.

Because a difference occurs between a display interface of the billing details and a display interface of the return cash details, different sub-types may be set for the display interface of the billing details and the display interface of the return cash details, to encapsulate codes corresponding to the interface difference. Then, respective detail lists, itemized details, requests for detail screening items, list titles, detail titles, and the like are generated based on enumeration values of the bill details and the return cash details. Identifiers of all the values are predefined and listed through the enumeration values to define an ordered set, thus realizing data consistency.

In some implementations, frozen processing or unfrozen processing and quota adjustment processing may also be performed on the virtual securities payment card.

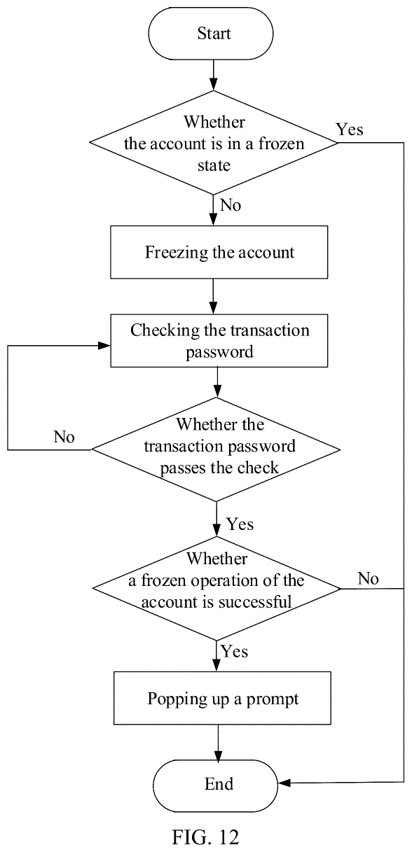

Referring to FIG. 12, FIG. 12 is a schematic diagram of performing the frozen processing on the virtual securities payment card. As illustrated in FIG. 12, a frozen request for the virtual securities payment card initiated by the requester is received. It is detected whether the virtual securities payment card is in a frozen state based on the frozen request. In response to the virtual securities payment card being not in the frozen state, the account is frozen. The transaction password verification request is transmitted to the terminal, to obtain a transaction password inputted by the requester to the terminal, thus checking whether the transaction password is correct. In addition, it is detected whether a frozen operation of the account is successful after the transaction password passes the check. In response to detecting that the frozen operation of the account is successful, a successful frozen prompt is popped up. In response to detecting that the frozen operation of the account is not successful, the device returns to reprocess. It can be understood that a process of performing the unfrozen processing on the virtual securities payment card is similar to the process of performing the frozen processing on the virtual securities payment card as described above, and details are omitted herein.

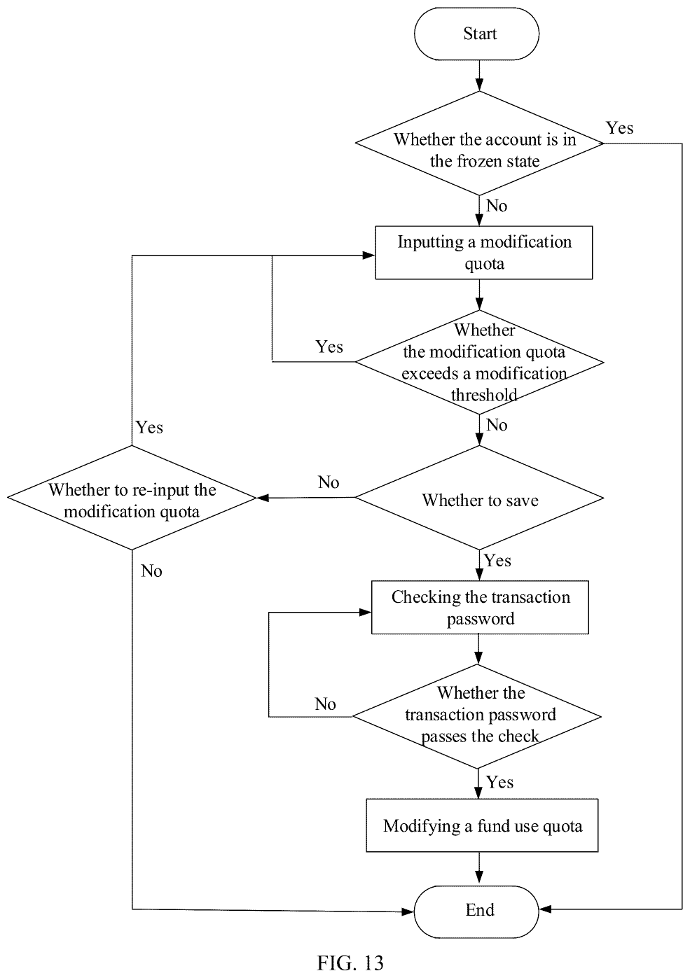

Referring to FIG. 13, FIG. 13 is a schematic diagram of performing payment quota adjustment processing on the virtual securities payment card. As illustrated in FIG. 13, a payment quota adjustment request initiated by the requester for the virtual securities payment card is received. It is detected whether the virtual securities payment card is in the frozen state based on the payment quota adjustment request. In response to the virtual securities payment card being not in the frozen state, a modification quota inputted by the requester to the terminal is obtained. Then, it is checked whether the modification quota exceeds a modification threshold. In response to the modification quota not exceeding the modification threshold, it is prompted whether to save the modification quota. In response to receiving an instruction of the requester for canceling saving, it is prompted for the requester whether to re-input the modification quota. In response to receiving an instruction of the requester for determining to save, the transaction password verification request is transmitted to the terminal, to obtain the transaction password inputted by the requester to the terminal. Further, it is checked whether the transaction password is correct. In response to the transaction password being correct, the payment quota is modified based on the modified quota.

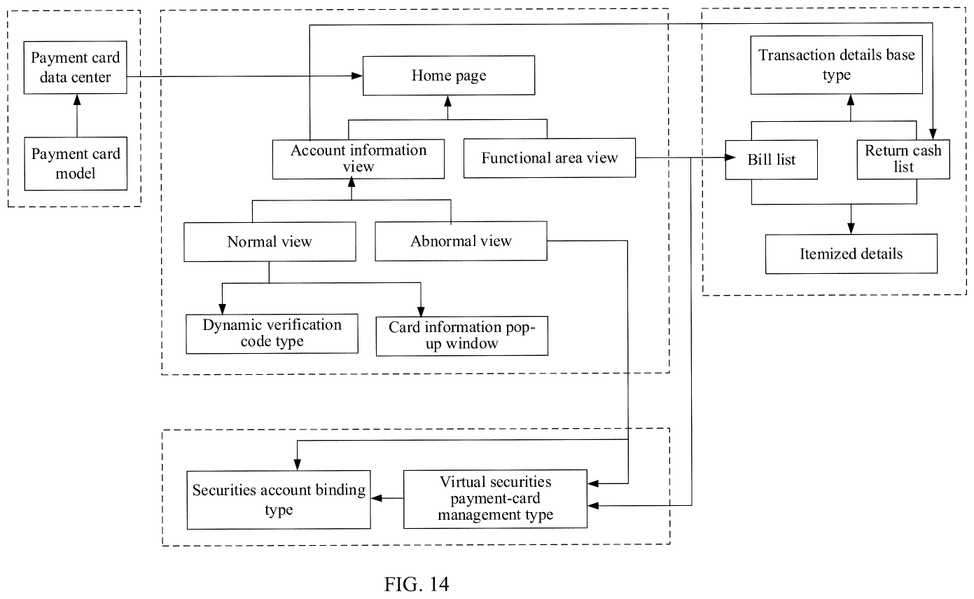

In some implementations, referring to FIG. 14, FIG. 14 is a schematic diagram of a unified model language (UML) of virtual securities payment card management software provided to the terminal. Next, each type is described below in combination with FIG. 14.

A “payment card data center” is used for maintaining a “payment card model” and its related information, and maintaining a related cache operation, to provide a reading and writing entrance of local virtual securities payment card information to an outside world.

The “payment card model” is used for providing a parameter structure of the virtual security payment card.

A “home page” mainly provides account information, a function entrance, and the like of each of the virtual securities payment card and the virtual securities payment card management software.

An “account information view” is a main view of the home page, which provides an access entrance to the return cash list, a “normal view” including an unfrozen virtual securities payment card completing binding of an existing securities account, and an “abnormal view” including a virtual securities payment card that does not complete the binding of the securities account or that has been frozen.

A virtual securities payment card in the “normal view” needs to perform dynamic verification code verification through a “dynamic verification code type”. A card number, a security code, a validity period, and other information of the virtual securities payment card are obtained through a “card information pop-up window”.

The “abnormal view” provides access entrances to a “securities account binding type” and a “virtual securities payment card management type”, to perform operations such as the binding of the securities accounts, the unfreezing of the virtual securities payment card, and the payment quota adjustment.

A “functional area view” is used for providing access entrances to the “bill list” and the “card management type”. The “itemized details” are used for querying detailed information of a bill of a single term or the return cash in each of the “bill list” and the “return cash list”.

A “transaction details base type” is abstracted for the “bill list” and the “return cash list” to encapsulate all the same interface display logic, and different interface logics are stripped, to reduce a quantity of codes for the interface development, facilitating subsequent maintenance and management of related codes displayed on the interface.

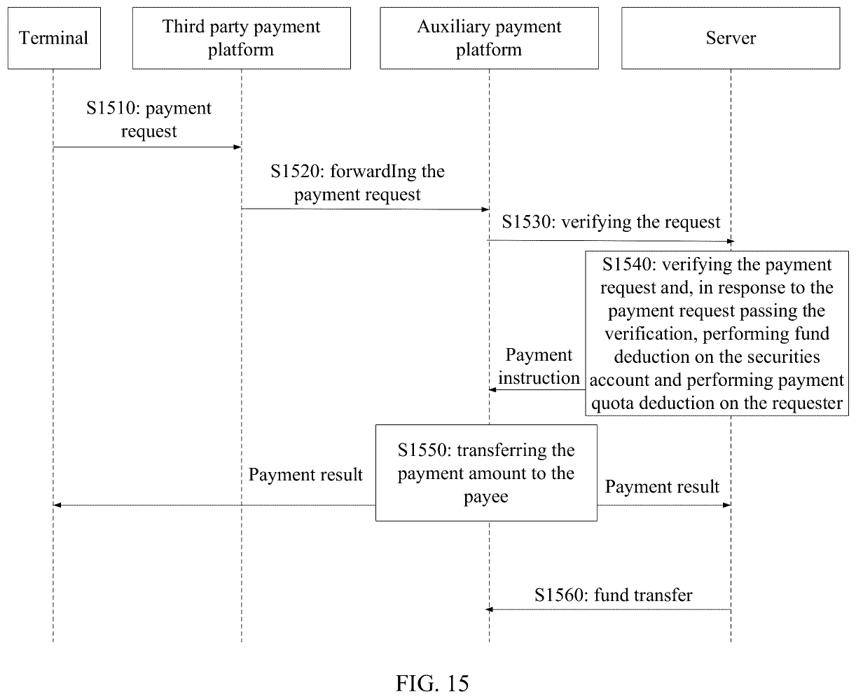

In some implementations, referring to FIG. 15, FIG. 15 is a flowchart of a blockchain-based payment control method according to an embodiment of the present disclosure. Referring to FIG. 15, the blockchain-based payment control method at least includes steps S1510 to S1580, which are described in detail below.

At step S1510, a terminal transmits a payment request for a securities account to a third-party payment platform. The payment request includes a payment amount, a payee, and an identity of the virtual securities payment card.

At step S1520, the third-party payment platform forwards the payment request to an auxiliary payment platform.

At step S1530, the auxiliary payment platform transmits a verification request to a server based on the payment request.

At step S1540: the server verifies the payment request based on the verification request, and in response to a verification result of verifying the payment request by the server being passing the verification, performs fund deduction on the securities account based on the payment amount, deducts a quota corresponding to the payment amount from a payment quota corresponding to the requester, and transmits a payment instruction to the auxiliary payment platform.

At step S1550, the auxiliary payment platform transfers the payment amount to the payee based on the payment instruction, and feeds back a transaction result to the third-party payment platform and the server.

At step S1560, the server transfers funds corresponding to the payment quota to the auxiliary payment platform.

After the payment request passes the verification, in the present disclosure, the fund deduction may be performed on the securities account, and the auxiliary payment platform may be instructed to advance the payment amount, to transfer the corresponding payment amount to the payee, thus ensuring that a payment business may be completed timely. Then, a specific advance of the auxiliary payment platform is transferred to the auxiliary payment platform, to complete the payment process. In this way, a problem of low fund use efficiency occurring in bank-securities transfer because the funds in the securities account are not directly available is solved, which simplifies steps of a user using the funds in the securities account, thus improving data throughput performance of a payment scenario and improving real-time performance in payment.

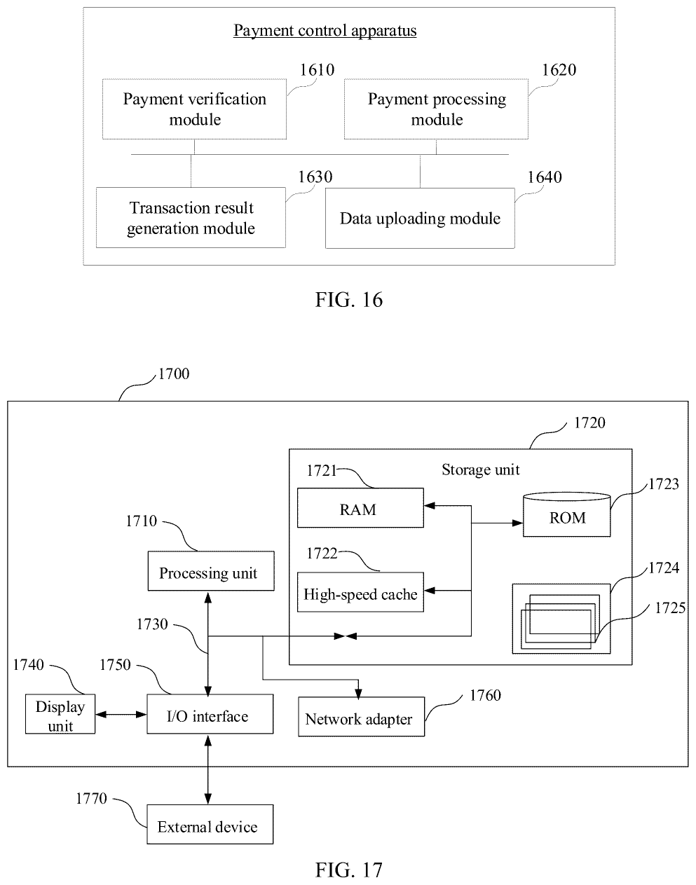

FIG. 16 is a block diagram of a payment control apparatus according to an embodiment of the present disclosure. As illustrated in FIG. 16, the apparatus includes a payment verification module 1610, a payment processing module 1620, a fund transfer module 1630, and a data uploading module 1640. The payment verification module 1610 is configured to verify a payment request for a securities account initiated by a requester. The payment request includes a payment amount and a payee. The payment processing module 1620 is configured to, in response to the payment request passing the verification, perform fund deduction on the securities account based on the payment amount, deduct a quota corresponding to the payment amount from a payment quota corresponding to the requester, and instruct an auxiliary payment platform to transfer the payment amount to the payee. The fund transfer module 1630 is configured to transfer funds corresponding to the payment quota to the auxiliary payment platform to generate a transaction result. The data uploading module 1640 is configured to verify the transaction result through a smart contract and upload data generated during the payment to a blockchain in response to the transaction result passing the verification.

In an embodiment of the present disclosure, the fund transfer module 1630 may further include: a quota change-value determination unit configured to obtain a quota change value of a payment quota corresponding to the auxiliary payment platform within a predetermined time period; and a transfer unit configured to transfer funds corresponding to the quota change value to the auxiliary payment platform.

In an embodiment of the present disclosure, the payment control apparatus further includes a securities account determination unit, a securities account selection unit, and a payment link establishment unit. The payment control apparatus further includes: the securities account determination unit configured to, before determining a to-be-paid securities account included in the virtual securities payment card based on the payment request for the virtual securities payment card initiated by the requester, determine a securities account available for payment based on a binding request for a securities account initiated by the requester; the securities account selection unit configured to transmit the securities account available for payment to the requester to receive securities account selection information fed back by the requester for the securities account available for payment, to obtain a to-be-bound securities account; and the payment link establishment unit configured to establish a payment link with the to-be-bound securities account.

In an embodiment of the present disclosure, the securities account determination unit may include: a securities account state query unit configured to query a securities account state of a securities account corresponding to the requester; a securities account credibility calculation unit configured to calculate credibility of a securities account with the securities account state being a normal state based on historical transaction information of the securities account with the securities account state being the normal state; and a payable determination unit configured to take a securities account with credibility satisfying a predetermined condition as the securities account available for payment.

In an embodiment of the present disclosure, the securities account selection unit may include: a securities account verification request unit configured to transmit a securities account verification request to the requester in response to the securities account selection information; a securities account verification-information receiving unit configured to receive securities account verification information fed back by the requester based on the securities account verification request; a verification unit configured to perform securities account verification on a selected securities account based on the securities account verification information; and a to-be-bound confirmation unit configured to, in response to the selected securities account passing the verification, take the selected securities account as the to-be-bound securities account.

In an embodiment of the present disclosure, the payment link establishment unit may include: a user information obtaining unit configured to obtain user information of the requester; a requester credibility determination unit configured to obtain credibility of the requester based on the user information; a payment quota confirmation unit configured to generate the payment quota corresponding to the requester based on the credibility of the requester; and a payment link establishment unit configured to establish the payment link with the to-be-bound securities account based on the payment quota corresponding to the requester.

In an embodiment of the present disclosure, the payment control apparatus may further include: a payment data query-request receiving unit configured to receive a payment data query request for the securities account initiated by the requester, the payment data query request carrying a data type of to-be-queried payment data; a data display strategy and payment data record determination unit configured to determine a data display strategy matching the data type and query a payment data record corresponding to the data type; and a query feedback unit configured to transmit the data display strategy and the payment data record to the requester, to allow a terminal corresponding to the requester to display the payment data record based on the data display strategy.

In this exemplary payment control apparatus, funds that need to be used for payment in the to-be-paid securities account are locked through the smart contract, and the fund transfer is performed on the payee through the auxiliary payment platform, to ensure that the payment business may be completed timely. Then, after the smart contract determines that the auxiliary payment platform completes the payment, a fund transfer operation is performed on the locked funds in the to-be-paid securities account, to transfer funds corresponding to the payment amount in the to-be-paid securities account to the auxiliary payment platform. In this way, the problem of the low fund use efficiency occurring in bank-securities transfer because the funds in the securities account are not directly available is solved, which simplifies the steps of the user using the funds in the securities account, making it beneficial to improve the use efficiency of the funds in the securities account and improve the use safety of the funds in the securities account.

It needs to be noted that the blockchain-based payment control apparatus according to the above embodiments belongs to the same concept as the blockchain-based payment control method according to the above embodiments. Specific manners where various modules and units perform operations are described in detail in the method embodiments, and details are omitted herein. In practical applications, in the blockchain-based payment control apparatus provided by the above embodiments, the above functions may be allocated to be completed by different functional modules as needs, i.e., an internal structure of the apparatus is divided into different functional modules, to complete all or some of the functions as described above, and is not limited herein.

FIG. 17 shows a schematic structural diagram of a computer system of an electronic device suitable for implementing the embodiments of the present disclosure.

It needs to be noted that the computer system 1700 of the electronic device illustrated in FIG. 17 is merely an example, which should not bring any limitation on functions and use scopes of the embodiments of the present disclosure.

As illustrated in FIG. 17, the electronic device 1700 is represented in the form of a general purpose computing device. Components of the electronic device 1700 may include, but are not limited to, the at least one processing unit 1710 as described above, the at least one storage unit 1720 as described above, a bus 1730 connected to different system components (including the storage unit 1720 and the processing unit 1710), and a display unit 1740.

The storage unit stores a program code, and the program code may be executed by the processing unit 1710, causing the processing unit 1710 to perform steps according to various exemplary embodiments of the present disclosure described in the above-described “exemplary method” part of this specification.

The storage unit 1720 may include a readable medium in the form of a volatile storage unit, such as a random access storage unit (RAM) 1721 and/or a high-speed cache storage unit 1722, and may further include a read-only storage unit (ROM) 1723. The storage unit 1720 may also include a program/utility tool 1724 having a set (at least one) of program modules 1725. Such a program module 1725 includes, but is not limited to, an operation system, one or more application programs, other program modules, and program data. Each of these examples or some combinations of these examples may include implementations of a network environment.

The bus 1730 may represent one or more of several types of bus structures, including a memory unit bus or a memory unit controller, a peripheral bus, a graphics acceleration port, a processing unit, or a local bus using any of a variety of bus structures.

The electronic device 1700 may also communicate with one or more external devices 1770 (such as a keyboard, a pointing device, and a Bluetooth device) and may also communicate with one or more devices that enable the user to interact with the electronic device 1700, and/or any device (such as a router and modem) that enables the electronic device 1700 to communicate with one or more other computing devices. Such communication may be performed through an input/output (I/O) interface 1750. Moreover, the electronic device 1700 may also communicate with one or more networks (such as a local area network (LAN), a wide area network (WAN), and/or a public network, such as the Internet) through a network adapter 1760. As shown in the drawings, the network adapter 1760 communicates with other modules of the electronic device 1700 through the bus 1730. It should be understood that, although not shown in the drawings, other hardware and/or application modules may be used in combination with the electronic device 1700, and include, but are not limited to, microcode, device drivers, redundant processing units, external disk drive arrays, RAID systems, tape drives, and data backup storage systems.

In particular, according to the embodiments of the present disclosure, the processes described above with reference to the flowcharts may be implemented as computer applications. For example, the embodiments of the present disclosure include a computer program product. The computer program product includes a computer program carried on a computer readable medium, and the computer program includes a computer program used for performing the method shown in the flowcharts. When executed by the processing unit 1710, the computer program performs various functions defined in the system of the present disclosure.

It needs to be noted that the computer-readable medium illustrated in the embodiments of the present disclosure may be a computer-readable signal medium, a computer-readable storage medium, or any combination of the above two. The computer-readable storage medium may be, for example, an electrical, magnetic, optical, electromagnetic, infrared, or semiconductor system, apparatus, or device, or any combination thereof. More specific examples of the computer-readable storage medium may include, but are not limited to, an electrical connection having one or more wires, a portable computer magnetic disk, a hard disk, a random access memory (RAM), a read only memory (ROM), an erasable programmable read only memory (EPROM), a flash memory, an optical fiber, a portable compact disc read-only memory (CD-ROM), an optical storage device, a magnetic storage device, or any suitable combination thereof. In the present disclosure, the computer-readable storage medium may be any tangible medium containing or storing a program that may be used by or in combination with a requesting execution system, apparatus, or device. In the present disclosure, the computer-readable signal medium may include a data signal propagated in a baseband or propagated as a part of a carrier wave, in which a computer-readable computer program is carried. Such a propagated data signal may take a variety of forms, including, but not limited to, electromagnetic signals, optical signals, or any suitable combination of the foregoing. A computer-readable signal medium may also be any computer-readable medium other than the computer-readable storage medium, and the any computer-readable medium may transmit, propagate, or transfer a program for use by or in combination with a requesting execution system, apparatus, or device. A computer program contained on the computer-readable medium may be transmitted using any suitable medium, including, but not limited to, a wireless medium, a wired medium, or the like, or any suitable combination of the foregoing.

Flowcharts and block diagrams in the drawings illustrate architectures, functions, and operations that are possible implemented by systems, methods, and computer program products according to various embodiments of the present disclosure. Each block in the flowcharts or block diagrams may represent a part of a module, a program segment, or a code, and the part of the module, the program segment, or the code contains one or more executable requests for realizing specified logical functions. It should also be noted that, in some alternative implementations, functions noted in the blocks may also occur in an order different from an order noted in the drawings. For example, two blocks represented in succession may actually be executed substantially in parallel or may sometimes be executed in a reverse order, depending on the functions involved. It is also noted that each block in the block diagrams or flowcharts and combinations of the blocks in the block diagrams or flowchart may be implemented with a dedicated hardware-based system that performs a specified function or operation, or may be implemented with a combination of dedicated hardware and computer requests.

The involved units described in the embodiments of the present disclosure may be implemented by an application program or hardware, and the described units may also be disposed in the processor. In some cases, names of these units do not constitute a limitation of the units themselves.

Another aspect of the present disclosure further provides a computer-readable storage medium having a computer program stored thereon. The computer program, when executed by a processor, implements the blockchain-based payment control method as described above. The computer-readable storage medium may be included in the electronic device described in the above embodiments or may exist alone without being assembled into the electronic device.

Another aspect of the present disclosure further provides a computer program product or a computer program. The computer program product or the computer program includes a computer request stored in the computer readable storage medium. A processor of the computer device reads the computer request from the computer-readable storage medium. The processor executes the computer request, such that the computer device performs the blockchain-based payment control method provided in the various embodiments described above.

The above contents are only preferred exemplary embodiments of the present disclosure, rather than implementations for limiting the present disclosure. Those of ordinary skill in the art can very conveniently perform corresponding adaptations or modifications based on the main concept and spirit of the present disclosure. Therefore, the protection scope of the present disclosure shall be subject to the protection scope claimed by the claims.

What is claimed is:

1. A blockchain-based payment control method, comprising:
determining a securities account available for payment based on a binding request for a securities account initiated by a requester;
transmitting the securities account available for payment to the requester to receive securities account selection information fed back by the requester for the securities account available for payment, to obtain a to-be-bound securities account;
establishing a payment link with the to-be-bound securities account, the payment link being used to invoke the securities account to use fund in the securities account;
verifying a payment request for a securities account initiated by the requester, wherein the payment request comprises a payment amount and a payee;
in response to the payment request passing the verification, performing fund deduction on the securities account based on the payment amount through the payment link, deducting a quota corresponding to the payment amount from a payment quota corresponding to the requester, and instructing an auxiliary payment platform to transfer the payment amount to the payee;
transferring funds corresponding to the payment quota to the auxiliary payment platform to generate a transaction result; and
verifying the transaction result through a smart contract and uploading data generated during the payment to a blockchain in response to the transaction result passing the verification.

2. The method according to claim 1, wherein said transferring the funds corresponding to the payment quota to the auxiliary payment platform comprises:
obtaining a quota change value of a payment quota corresponding to the auxiliary payment platform within a predetermined time period; and
transferring funds corresponding to the quota change value to the auxiliary payment platform.

3. The method according to claim 1, wherein said determining the securities account available for payment based on the binding request for the securities account initiated by the requester comprises:
querying a securities account state of a securities account corresponding to the requester;
calculating credibility of a securities account with the securities account state being a normal state, based on historical transaction information of the securities account with the securities account state being the normal state; and
taking a securities account with credibility satisfying a predetermined condition as the securities account available for payment.

4. The method according to claim 1, wherein said transmitting the securities account available for payment to the requester to receive the securities account selection information fed back by the requester for the securities account available for payment to obtain the to-be-bound securities account comprises:
transmitting a securities account verification request to the requester in response to the securities account selection information;
receiving securities account verification information fed back by the requester based on the securities account verification request;
performing securities account verification on a selected securities account based on the securities account verification information; and
in response to the selected securities account passing the verification, taking the selected securities account as the to-be-bound securities account.

5. The method according to claim 1, wherein said establishing the payment link with the to-be-bound securities account further comprises:
obtaining user information of the requester;
obtaining credibility of the requester based on the user information;
generating the payment quota corresponding to the requester based on the credibility of the requester; and
establishing the payment link with the to-be-bound securities account based on the payment quota corresponding to the requester.

6. The method according to claim 1, further comprising:
receiving a payment data query request for the securities account initiated by the requester, the payment data query request carrying a data type of to-be-queried payment data;
determining a data display strategy matching the data type and querying a payment data record corresponding to the data type; and
transmitting the data display strategy and the payment data record to the requester, to allow a terminal corresponding to the requester to display the payment data record based on the data display strategy.

7. An electronic device, comprising:
one or more processors; and
a storage apparatus for storing one or more programs, wherein the one or more programs, when executed by the electronic device, cause the electronic device to implement a blockchain-based payment control method, the method comprising:
determining a securities account available for payment based on a binding request for a securities account initiated by a requester;
transmitting the securities account available for payment to the requester to receive securities account selection information fed back by the requester for the securities account available for payment, to obtain a to-be-bound securities account;
establishing a payment link with the to-be-bound securities account, the payment link being used to invoke the securities account to use fund in the securities account;
verifying a payment request for a securities account initiated by the requester, wherein the payment request comprises a payment amount and a payee;
in response to the payment request passing the verification, performing fund deduction on the securities account based on the payment amount through the payment link, deducting a quota corresponding to the payment amount from a payment quota corresponding to the requester, and instructing an auxiliary payment platform to transfer the payment amount to the payee;
transferring funds corresponding to the payment quota to the auxiliary payment platform to generate a transaction result; and
verifying the transaction result through a smart contract and uploading data generated during the payment to a blockchain in response to the transaction result passing the verification.

8. The electronic device according to claim 7, wherein that the one or more programs, when executed by the electronic device, cause the electronic device to implement the operation of transferring the funds corresponding to the payment quota to the auxiliary payment platform comprises that the one or more programs, when executed by the electronic device, cause the electronic device to implement:
obtaining a quota change value of a payment quota corresponding to the auxiliary payment platform within a predetermined time period; and
transferring funds corresponding to the quota change value to the auxiliary payment platform.

9. The electronic device according to claim 7, wherein that the one or more programs, when executed by the electronic device, cause the electronic device to implement the operation of determining the securities account available for payment based on the binding request for the securities account initiated by the requester comprises that the one or more programs, when executed by the electronic device, cause the electronic device to implement:
querying a securities account state of a securities account corresponding to the requester;
calculating credibility of a securities account with the securities account state being a normal state, based on historical transaction information of the securities account with the securities account state being the normal state; and
taking a securities account with credibility satisfying a predetermined condition as the securities account available for payment.

10. The electronic device according to claim 7, wherein that the one or more programs, when executed by the electronic device, cause the electronic device to implement the operation of transmitting the securities account available for payment to the requester to receive the securities account selection information fed back by the requester for the securities account available for payment to obtain the to-be-bound securities account comprises that the one or more programs, when executed by the electronic device, cause the electronic device to implement:
transmitting a securities account verification request to the requester in response to the securities account selection information;
receiving securities account verification information fed back by the requester based on the securities account verification request;
performing securities account verification on a selected securities account based on the securities account verification information; and
in response to the selected securities account passing the verification, taking the selected securities account as the to-be-bound securities account.

11. The method according to claim 7, wherein that the one or more programs, when executed by the electronic device, cause the electronic device to implement the operation of establishing the payment link with the to-be-bound securities account further comprises that the one or more programs, when executed by the electronic device, cause the electronic device to implement:
obtaining user information of the requester;
obtaining credibility of the requester based on the user information;
generating the payment quota corresponding to the requester based on the credibility of the requester; and
establishing the payment link with the to-be-bound securities account based on the payment quota corresponding to the requester.

12. The method according to claim 7, wherein the one or more programs, when executed by the electronic device, cause the electronic device further to implement:
receiving a payment data query request for the securities account initiated by the requester, the payment data query request carrying a data type of to-be-queried payment data;
determining a data display strategy matching the data type and querying a payment data record corresponding to the data type; and
transmitting the data display strategy and the payment data record to the requester, to allow a terminal corresponding to the requester to display the payment data record based on the data display strategy.

13. A non-transitory computer-readable medium, having a computer program stored thereon, wherein the computer program, when executed by a processor, implements a blockchain-based payment control method, the method comprising:
determining a securities account available for payment based on a binding request for a securities account initiated by a requester;
transmitting the securities account available for payment to the requester to receive securities account selection information fed back by the requester for the securities account available for payment, to obtain a to-be-bound securities account;
establishing a payment link with the to-be-bound securities account, the payment link being used to invoke the securities account to use fund in the securities account;
verifying a payment request for a securities account initiated by the requester, wherein the payment request comprises a payment amount and a payee;
in response to the payment request passing the verification, performing fund deduction on the securities account based on the payment amount through the payment link, deducting a quota corresponding to the payment amount from a payment quota corresponding to the requester, and instructing an auxiliary payment platform to transfer the payment amount to the payee;
transferring funds corresponding to the payment quota to the auxiliary payment platform to generate a transaction result; and
verifying the transaction result through a smart contract and uploading data generated during the payment to a blockchain in response to the transaction result passing the verification.

14. A computer program product, comprising a computer request, wherein the computer request, when executed by a processor, implements the payment control method according to claim 1.
